(19) United States
(12) Patent Application Publication
(10) Pub. No.: US 2005/0080666 A1
(43) Pub. Date: Apr. 14, 2005

(54) Doll history software

(76) Inventors: Laura Treibitz, Warwick, NY (US); Lloyd Treibitz, Warwick, NY (US); Eleanor Schmidt, New City, NY (US)

Correspondence Address: LITMAN LAW OFFICES, LTD., P.O. BOX 15035 CRYSTAL CITY STATION, ARLINGTON, VA, 22215, US

(21) Appl. No.: 10/681,159

(22) Filed: Oct. 9, 2003

(51) Int. Cl. G06F 17/60

(52) U.S. Cl. 705/14

(57) ABSTRACT

The doll history software is a computer program and system that implements a computerized method for interactive retail sale of a stuffed toy to a customer. The customer participates in interactive activities including inputting information relating to the stuffed toy, inputting the customer's personal identifying information, inputting information relating to a designated recipient for the stuffed toy. Additionally, the customer has her picture taken and interacts with a simulated handprint and footprint scanning operation that gives the effect that the hands and feet of the stuffed toy are being scanned for printing. A personalized memento is printed for the customer. The personalized memento may be in the form of a newspaper or newsletter front page bearing the photo of the customer, or of a birth certificate bearing hand and foot prints of the stuffed toy. Additionally, a memento in the form of a message medallion may be created.

### BACKGROUND OF THE INVENTION

1. Field of the Invention

The present invention relates to the retail sales of children's toys. More specifically, the invention is a doll history software program that provides a customer interactive environment allowing customers to create a personalized memento of the “birth” of a doll or stuffed toy, while recording customer information in a customer database.

2. Description of the Related Art

An emerging trend in retail sales is the sale of children's toys, such as dolls and stuffed toys, in an interactive environment where customers participate in making the toy that they will purchase. In addition to receiving a new toy, children delight in participating in the interactive, and often creative, process. At the end of the process, the child often receives a memento along with the toy, such as a “birth certificate” memorializing the “birth” of a stuffed animal.

It is desirable, to make the interactive experience more entertaining for children and other customers, to give the toy or memento a personalized feature.

Various systems have been devised that allow for the entry of personalized information to be formatted and printed on a personalized printout.

U.S. Pat. No. 5,761,662, issued on Jun. 2, 1998 to V. Dasan, discloses a system for personalized information retrieval using user-defined profiles. A user creates a profile that is used to create a personalized publication containing information that, based on the user's profile, is of interest to the user.

U.S. patent application Publication 2002/0077848, published on Jun. 20, 2002 for B. Campbell, discloses a method for creation of a customized book. The invention includes presenting a customizable template to a customer who provides the names of people, pets, and places that the customer is familiar with for incorporation into the customized book.

U.S. patent application Publication 2002/0127944, published on Sep. 12, 2002 for D. Spector, discloses a construction kit for custom toys or other personalized products. The kit includes a computer software program for creation of custom images conforming to the shape of a personalized product. The images are printed on a transfer medium such as a sheet of paper with an adhesive backing.

None of the above inventions and patents, taken either singly or in combination, is seen to describe the instant invention as claimed. Thus the doll history software of the present invention solving the aforementioned problems is desired.

### SUMMARY OF THE INVENTION

The doll history software of the present invention is a computer program, executed on a computer system, that provides a customer interactive environment allowing customers to create a personalized memento of the “birth” of a doll or stuffed toy, while recording customer information in a customer database.

An emerging trend in retail sales is the sale of children's toys, such as dolls and stuffed toys, in an interactive environment where customers participate in making the toy that they will purchase. In addition to receiving a new toy, children delight in participating in the interactive, and often creative, process. At the end of the process, the child often receives a memento along with the toy, such as a “birth certificate” memorializing the “birth” of a stuffed animal.

The doll history software of the present invention guides a customer through several interactive steps that relate to the customer's purchase of a stuffed doll, although the interactive steps are equally applicable to stuffed animals and other toys. The doll history software employs a graphical user interface (GUI) to prompt the customer to enter information about the doll, as well as customer information related to the purchase. The customer information is used to update a customer database that may be used by other computer applications, such as a mailing list. The doll information, along with the customer information, is used to create personalized mementos, such as a “newspaper birth announcement”, a “birth certificate”, and a personalized medallion. These personalized mementos are given to the customer along with the doll.

The doll history software also allows a customer to designate another recipient for the doll, if the purchase is to be a gift. For a gift purchase, the personalized mementos may be created using the name and personal information of the recipient instead of the customer. Both the customer and the recipient may be added into the customer database.

The doll history software also controls a digital camera, or a “webcam”, to create a digital image of the customer. The customer's image is added to the personalized memento given to the customer along with the doll.

The doll history software performs a simulated hand and foot scan, prompting a customer to place her doll's hands or feet on the computer screen to be “scanned”, and prints a birth certificate that includes an image of the doll's handprints and footprints.

Additionally, a personalized message may be entered and printed onto a message medallion that can be kept with the doll or worn as a necklace around the customer's neck.

Accordingly, it is a principal object of the invention to provide doll history software that creates a customer interactive environment, allowing customers to create a personalized memento of the “birth” of a doll or stuffed toy, while recording customer information in a customer database.

It is another object of the invention to provide doll history software that creates a customer interactive environment that captures personal information relating to the customer in a customer database.

It is a further object of the invention to provide doll history software that creates a customer interactive environment that creates a digital image of the customer and prints a personalized memento that includes the customer's image.

Still another object of the invention is to provide doll history software that creates a customer interactive environment that simulates a doll handprint and footprint scanner and prints a personalized memento that includes an image of the doll's handprints and footprints.

Yet another object of the invention is to provide doll history software that creates a customer interactive environment that allows a customer to enter a personalized message to be printed onto a message medallion.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a use case diagram depicting customer interactions with the doll history software of the present invention.

FIG. 2A is a block diagram of a computer system for executing the doll history software of the present invention.

FIG. 2B is a block diagram of a computer workstation in a computer system for executing the doll history software of the present invention.

FIG. 3 is a flow chart describing a start activity performed by the doll history software of the present invention.

FIGS. 4 and 5 are screen shots illustrating features of the start activity performed by the doll history software of the present invention.

FIG. 6 is a flow chart describing a doll information activity performed by the doll history software of the present invention.

FIG. 7 is a screen shot illustrating features of the doll information activity performed by the doll history software of the present invention.

FIG. 8 is a flow chart describing a customer information activity performed by the doll history software of the present invention.

FIGS. 9, 10, and 11 are screen shots illustrating features of the customer information activity performed by the doll history software of the present invention.

FIG. 12 is a flow chart describing a recipient designation activity performed by the doll history software of the present invention.

FIGS. 13, 14, 15, and 16 are screen shots illustrating features of a recipient designation activity performed by the doll history software of the present invention.

FIG. 17 is a flow chart describing a verify information activity performed by the doll history software of the present invention.

FIG. 18 is a screen shot illustrating features of the verify information activity performed by the doll history software of the present invention.

FIG. 19 is a flow chart describing a create newspaper activity performed by the doll history software of the present invention.

FIGS. 20, 21, and 22 are screen shots illustrating features of the create newspaper activity performed by the doll history software of the present invention.

FIG. 23 is a flow chart describing a create birth certificate activity performed by the doll history software of the present invention.

FIGS. 24A and 24B are screen shots illustrating features of the create birth certificate activity performed by the doll history software of the present invention.

FIG. 25 is a flow chart of a create message medallion activity performed by the doll history software of the present invention.

FIG. 26 is a screen shot illustrating features of the create message medallion activity performed by the doll history software of the present invention.

FIG. 27A is a perspective view of a message medallion of the present invention formed in a sheet of paper or card stock, defined by perforations to be removable from the paper or card stock.

FIG. 27B is a perspective view of the message medallion illustrated in FIG. 27A, showing the message medallion removed from the sheet of paper or card stock.

FIG. 28 is a perspective view of a doll with a message pocket for receiving a message medallion created by doll history software of the present invention.

Similar reference characters denote corresponding features consistently throughout the attached drawings.

### DETAILED DESCRIPTION OF THE PREFERRED EMBODIMENTS

The present invention is doll history software that, executed on a computer system, provides a customer interactive environment allowing customers purchasing a doll or stuffed toy to create a personalized memento of the “birth” of the doll or stuffed toy, while recording customer information in a customer database. The doll history software is a software package that is designed to run on a standalone computer system, or on one or more computers in a networked environment.

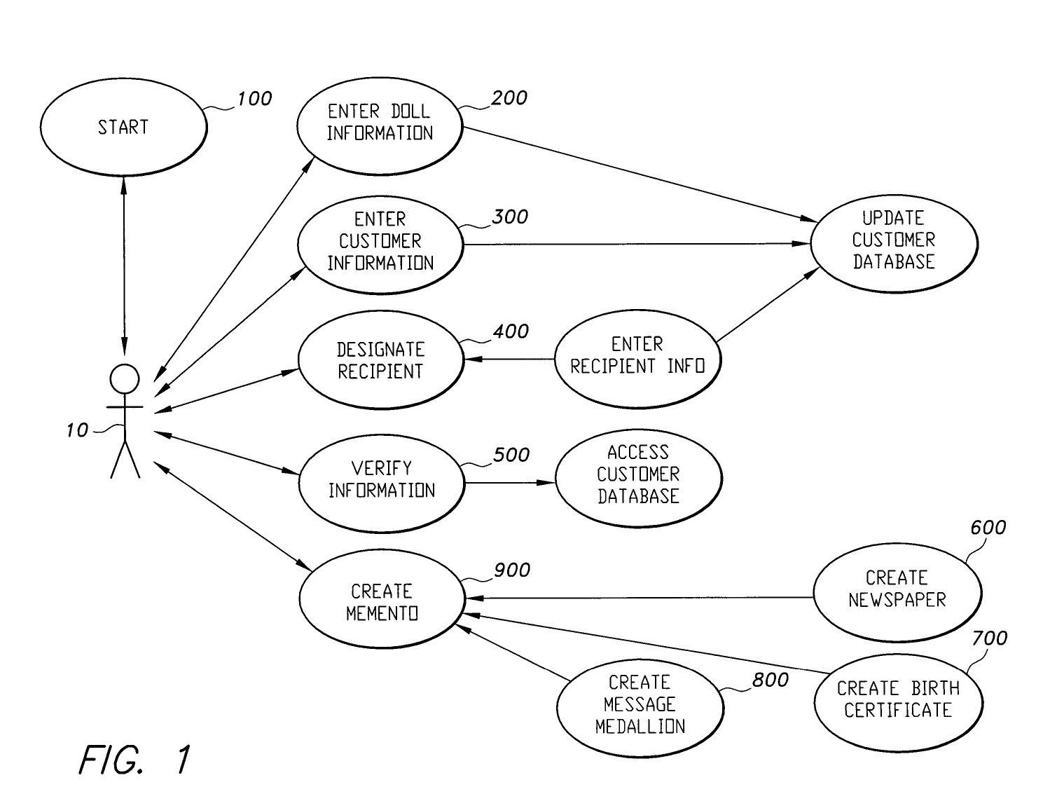

Referring to FIG. 1, the doll history software is characterized by the interaction of a customer 10 with a number of activities related to the retail purchase of a doll or a stuffed toy. The doll history software employs a graphical user interface (GUI) to guide the customer 10 through the activities. Activities include a start activity 100 wherein the customer interactive process is started, an enter doll information activity 200 wherein information about the purchased doll is entered, an enter customer information activity 300 wherein the customers information is entered, a designate recipient activity 400 wherein a recipient of the doll may be designated and the recipient's information entered, a verify information activity 500 wherein all entered information can be verified, and a create memento activity 900 wherein a personalized memento can be created and printed.

The doll history software creates a personalized memento in at least one of several forms. The memento may be in the form of a newspaper, bearing the photo of the customer along with a “birth announcement” of the doll. In another form, the memento is a “birth certificate” bearing hand and foot prints of the new doll. In yet another form, the memento is a message medallion printed with a personalized message. Thus, the create memento activity 900 includes at least one of a create newspaper activity 600, a create birth certificate activity 700, and a create message medallion activity 800.

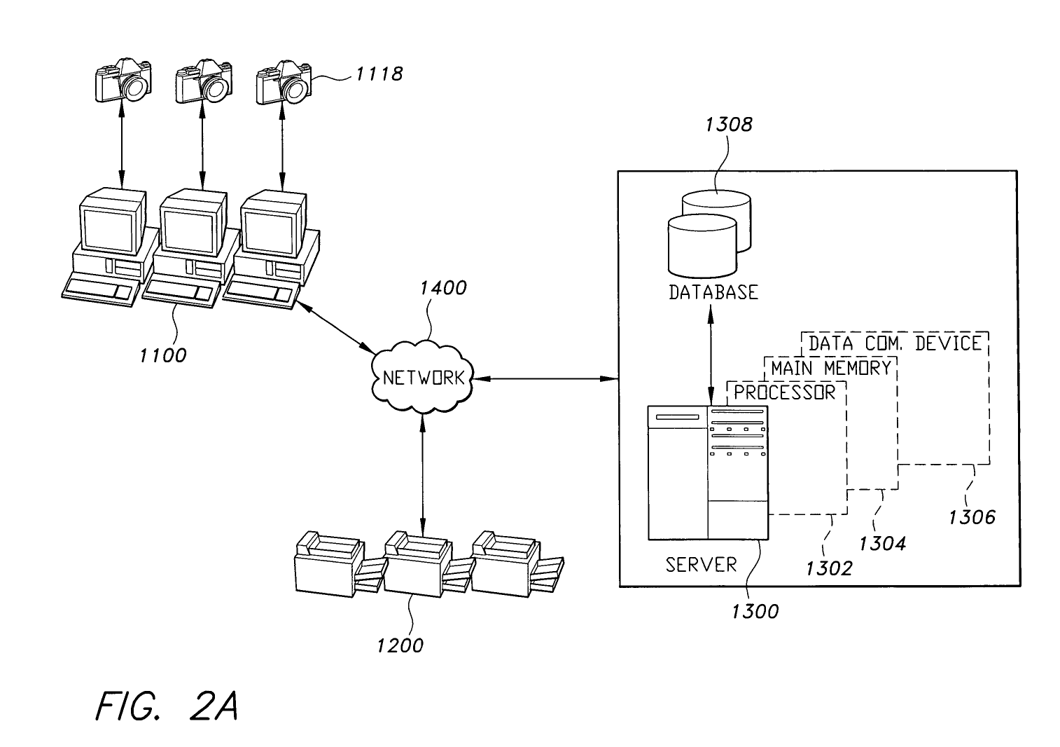

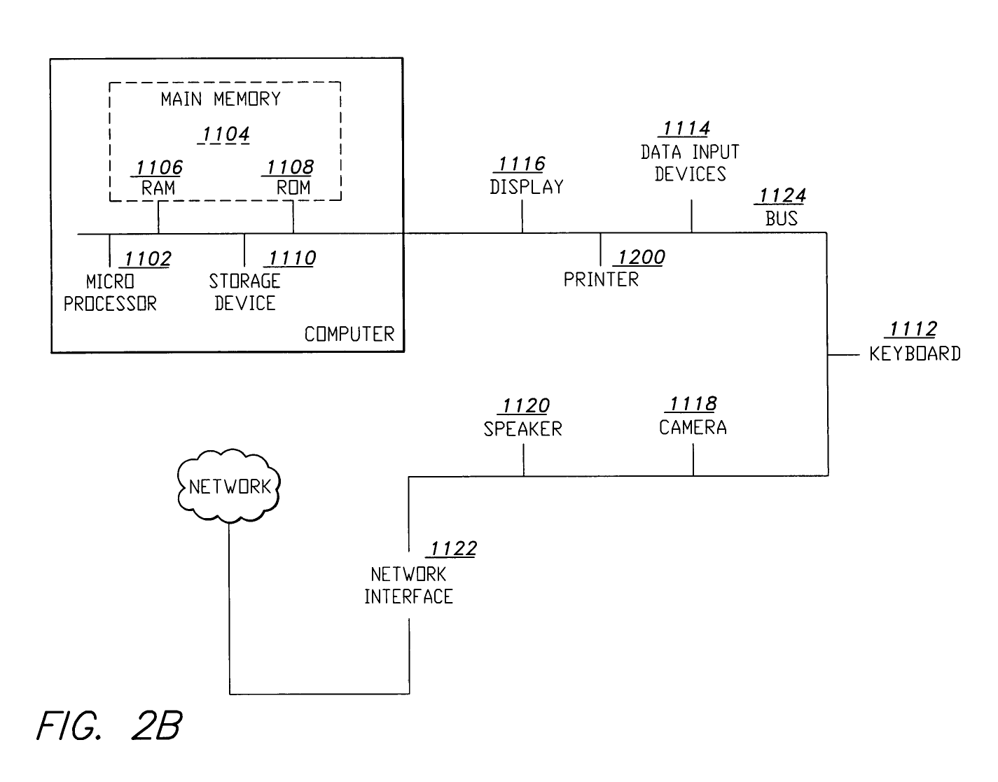

The doll history software can be run on a single, standalone, computer, or on one or more computers in a networked environment. FIG. 2A illustrates a preferred system configuration having at least one workstation computer 1100, at least one printer 1200, and at least one server computer 1300 connected to a network 1400, the at least one workstation computer 1100, the least one printer 1200, and the at least one server computer 1300 being in communication with one another over the network 1400. The server 1300 has a processor 1302 for processing instructions and an area of memory 1304 for executing program code under the direction of the processor 1302, and a data communication device 1306 for communicating on the network 1400. A database 1308 may reside in an area of disk storage on the server 1300 and be connected to the server memory by a bus, or may reside on a remote database server accessible by the server 1300, as is known in the art.

Turning to FIG. 2B, each workstation computer 1100 has a microprocessor 1102 connected by a bus 1124 to an area of main memory 1104, comprising both read only memory (ROM) 1108, and random access memory (RAM) 1106, and a storage device 1110 having means for reading a coded set of program instructions on a computer readable medium which may be loaded into RAM 1106 and executed by the microprocessor 1102. The workstation computer 1100 has a keyboard 1112, and may include other input devices 1114 such as a mouse, joystick, etc. The keyboard 1112 preferably includes, in addition to alpha-numeric keys, a plurality of color-coded keys. Additionally, the computer has a display 1116 for video display, a digital camera 1118, at least one audio speaker 1120, and a network communication interface 1122 for serial communications on a network or other serial communications link.

In embodiments where the doll history software is configured to run on a single standalone computer, a workstation computer 1100 operates as the standalone computer system. The printer 1200 is connected directly to the workstation computer 1100 by bus 1124, and the database 1308 is maintained on the workstation computer 1100.

The present invention includes software program code stored on a computer readable medium and operable in main memory 1104 on each workstation computer 1100. As used in the present application, the term “computer readable medium” refers to a hard disk drive, a floppy diskette, a ZIP disk or any other magnetic storage media capable of storing coded program instructions, an optical or laser storage device, such as a compact disk or laser disk, paper tape, punch cards, or any other media for the storage of program instructions readable by a storage device or reader. The computer code may be written in Microsoft's Visual Basic, Microsoft's Visual C++, or any other programming language known in the art to be suitable for creating GUI applications, and includes code for creating a graphical user interface to obtain information relating to a customer's purchase, code for updating the database 1308, and code for creating a personalized memento.

The computer code implements a graphical user interface (GUI) to guide a customer 10 through various activities as depicted in FIG. 1. The GUI presents several display pages that prompt the customer 10 to enter information or perform other actions. The GUI processes the information to update the database 1308 and to move on to further actions. In addition to the GUI, the computer code generates voice prompts, played on the at least one audio speaker 1120, that recite instructions presented graphically on the display pages.

In the following description, various screen shots are shown to illustrate features of the present invention. It will be understood that the screen shots are merely exemplary, and details of the implementation may vary consistent with the general description of the software.

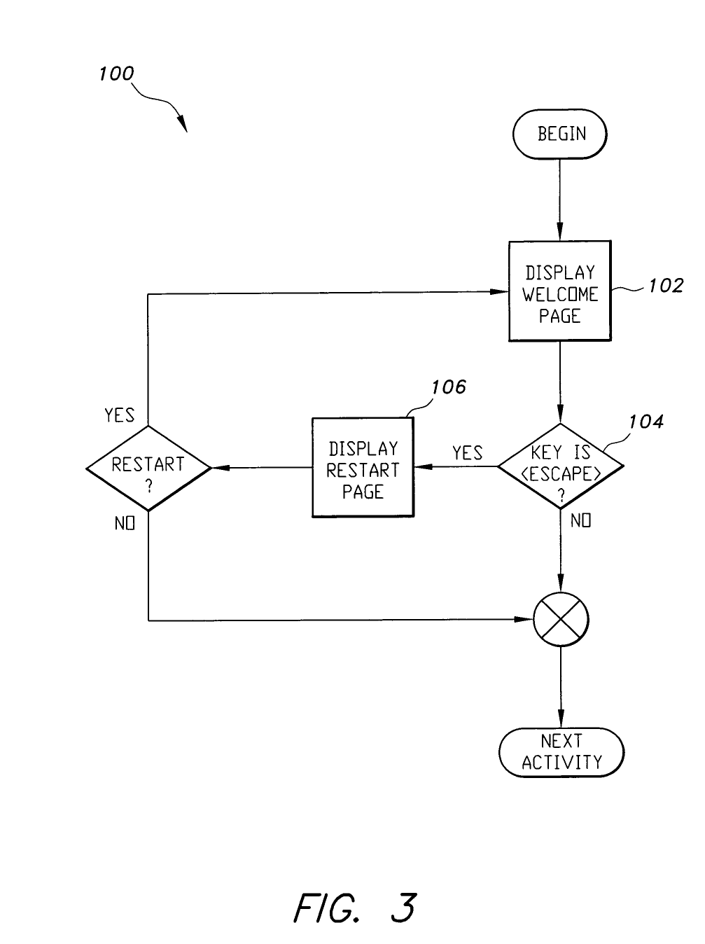

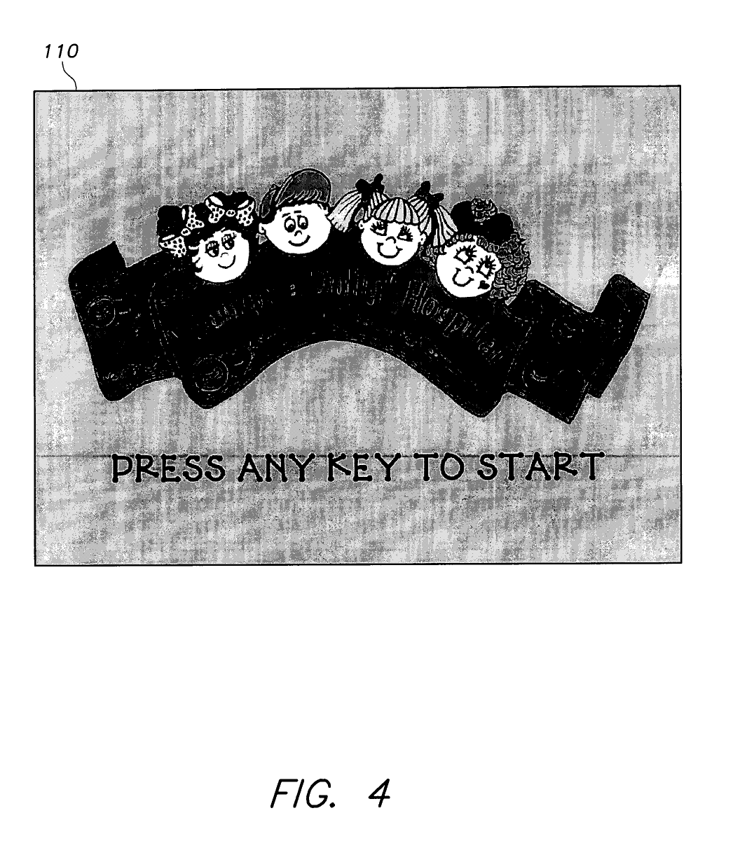

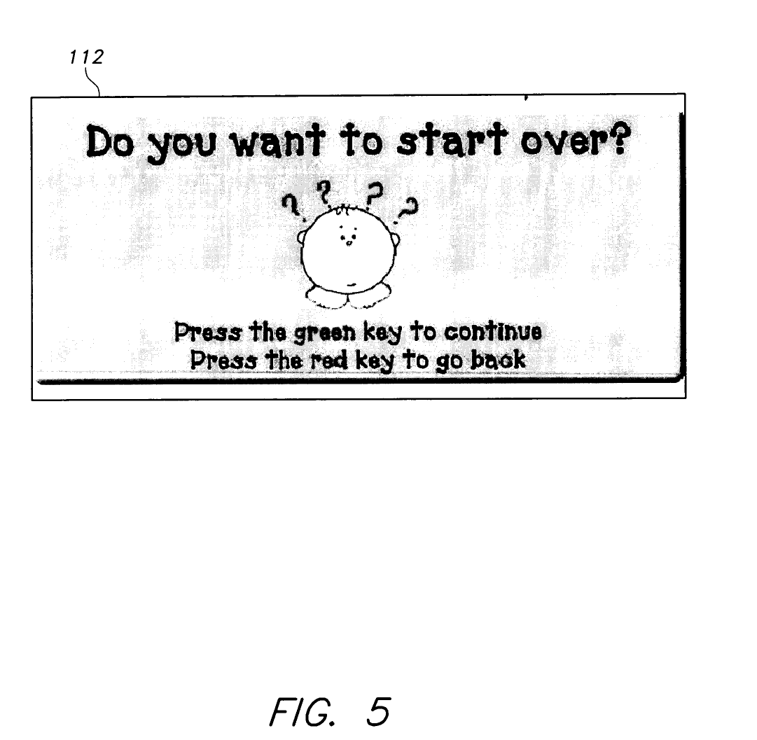

Turning to FIGS. 3-5, the start activity 100 is detailed. At step 102, the computer program code causes a welcome page 110, shown in FIG. 4, to be displayed on the workstation display 1116. The computer program code waits for a customer 10 to press any key on the keyboard 1112 to begin the doll history software's interactivity. When a key press is detected, at step 104, the start activity 100 is completed and the computer program code moves to the next activity. One exception is that a key may be designated as a restart key. If the key pressed is the restart key, the computer program code at step 106 displays a restart page 112, shown in FIG. 5, presenting the option to continue or to start over with the start activity 100. If the customer selects the option to start over, execution of the computer program code restarts at step 102 in the start activity 100. It should be noted that the restart key may be recognized during all activities by all GUI pages, and not just during the start activity 100. For simplicity, the restart function is only described here.

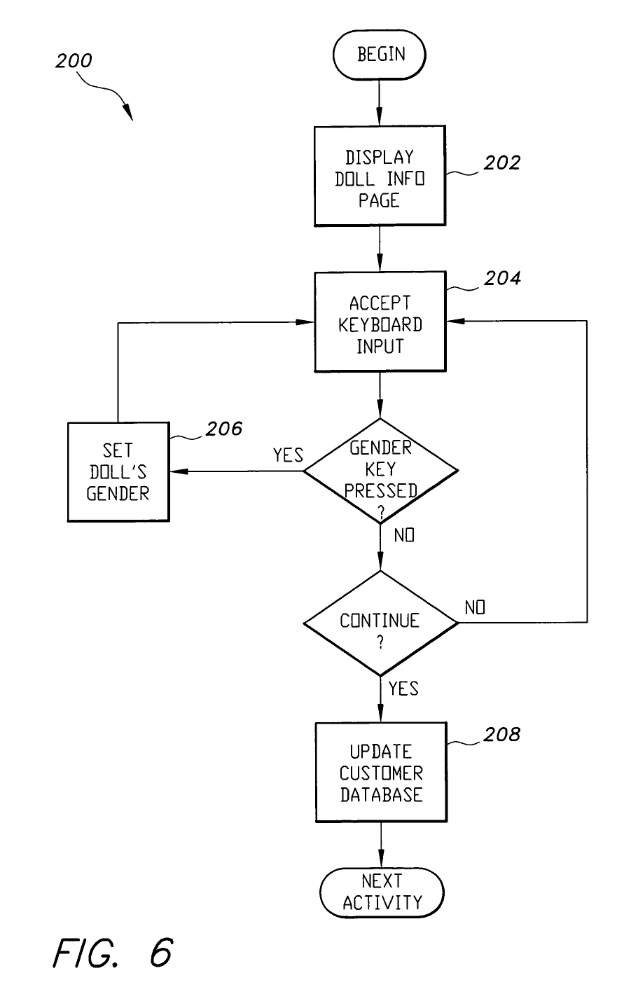

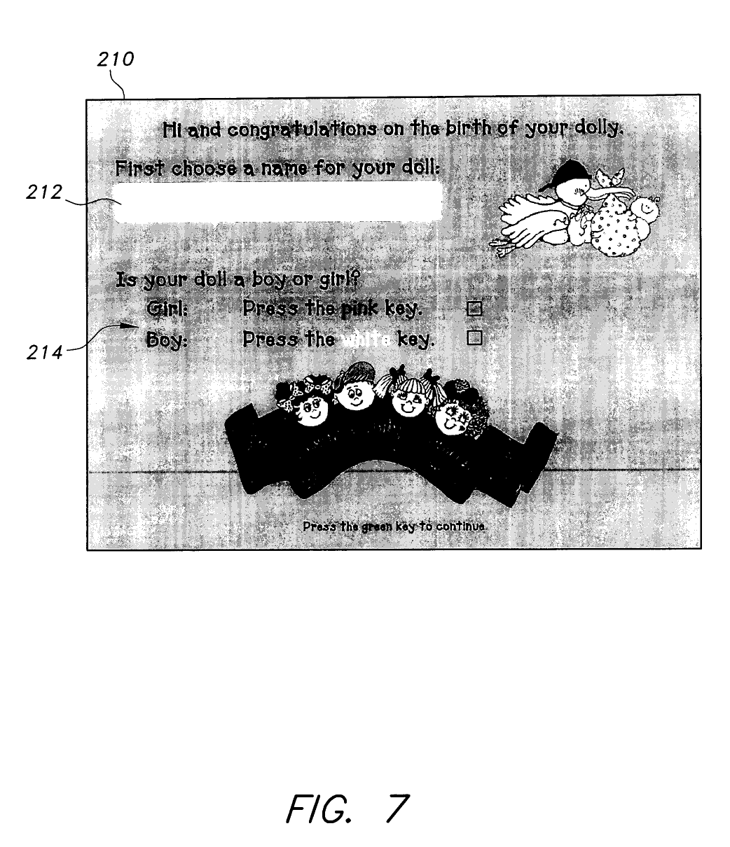

Turning now to FIGS. 6-7, the enter doll information activity 200 is detailed. It can be appreciated that the activities are independent of one another, and can be presented in any order. Activities are described in the order of the preferred embodiment. At step 202, the computer program code causes a doll information page 210, shown in FIG. 6, to be displayed on the workstation display 1116. The doll information page 210 includes a text box 212, for entry of the doll's name, as well as a selection list 214 allowing selection of the doll's gender. Computer program code at step 204 accepts keystrokes entered by the user. The keystrokes may be alphanumeric characters, which are entered into the textbox 212, or color-coded keys corresponding to the selections in the selection list 214, or a continue key. If one of the color-coded keys corresponding to the selections in the selection list 214 is pressed, the doll's gender is set at step 206. If the continue key is pressed, the database 1308 is updated at step 208 with the doll's name and gender, and the doll information activity 200 is completed and the computer program code moves to the next activity. As an alternative to the color-coded keys, selection list items can be selected with a mouse or other data input device 1114.

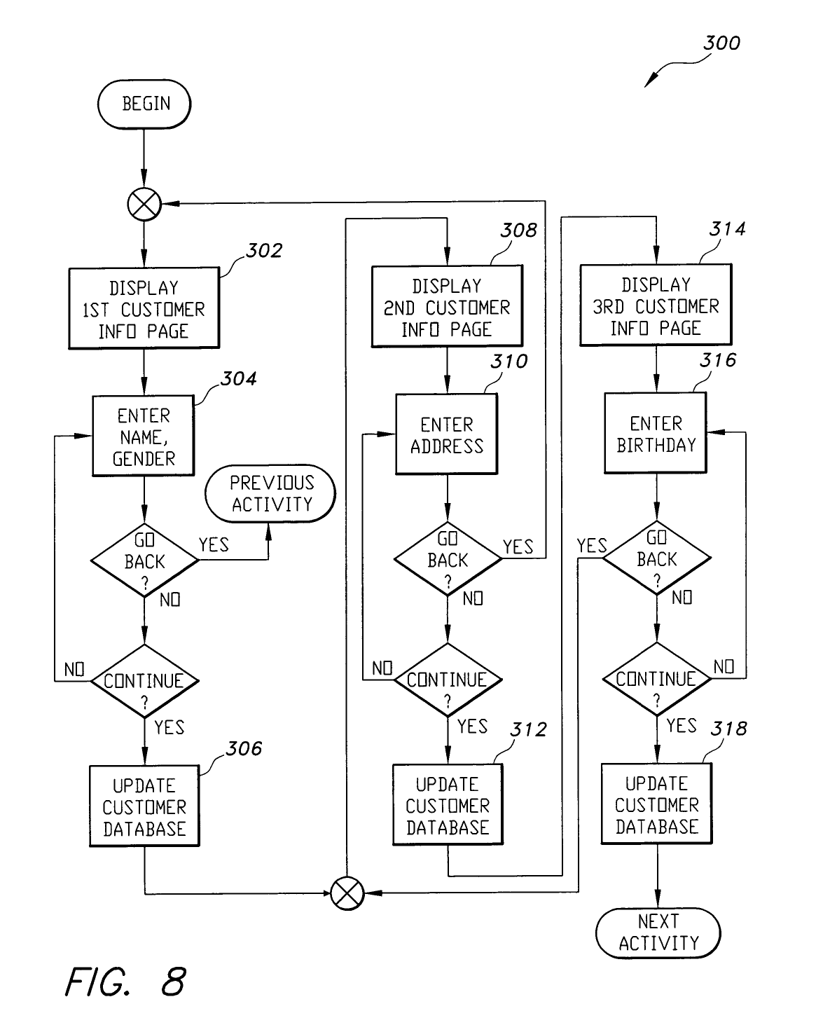

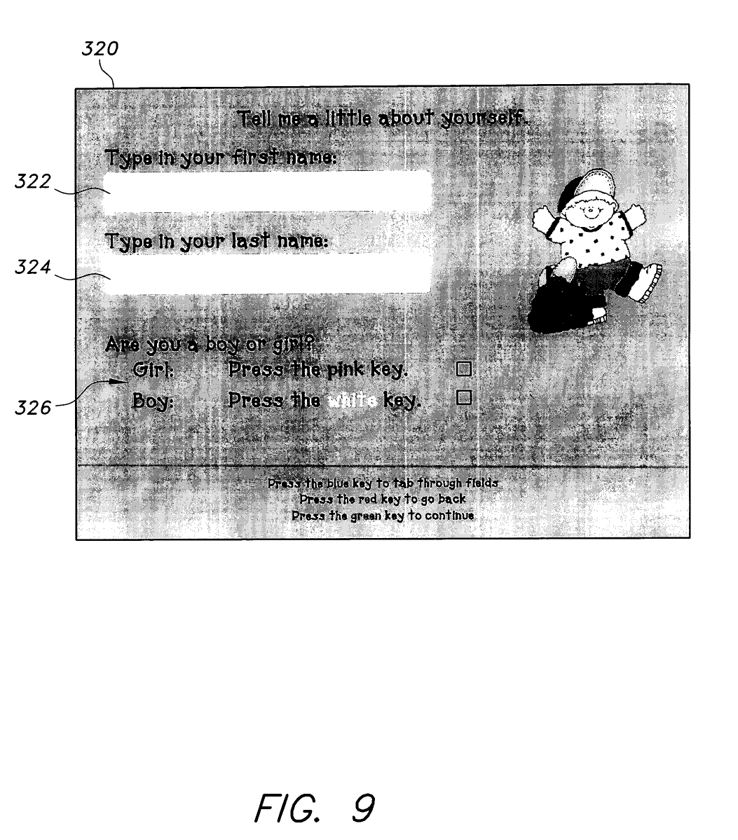

Turning now to FIGS. 8-11, the enter customer information activity 300 is detailed. Computer program code at step 302 causes a first customer information page 320, shown in FIG. 9, to be displayed on the workstation display 1116. The first customer information page 320 includes text boxes 322 and 324, for entry of the customer's first and last names, as well as a selection list 326 allowing selection of the customer's gender. At step 304, computer program code accepts keystrokes entered by the user. The keystrokes may be alphanumeric characters, which are entered into the textboxes 322, 324, color-coded keys corresponding to the selections in the selection list 326, or a continue key. If one of the color-coded keys corresponding to the selections in the selection list 326 is pressed, the customer's gender is set. If the continue key is pressed, computer program code at step 306 updates the database 1308 with the customer's name and gender. A “go back” key may be entered to revert to a previous activity.

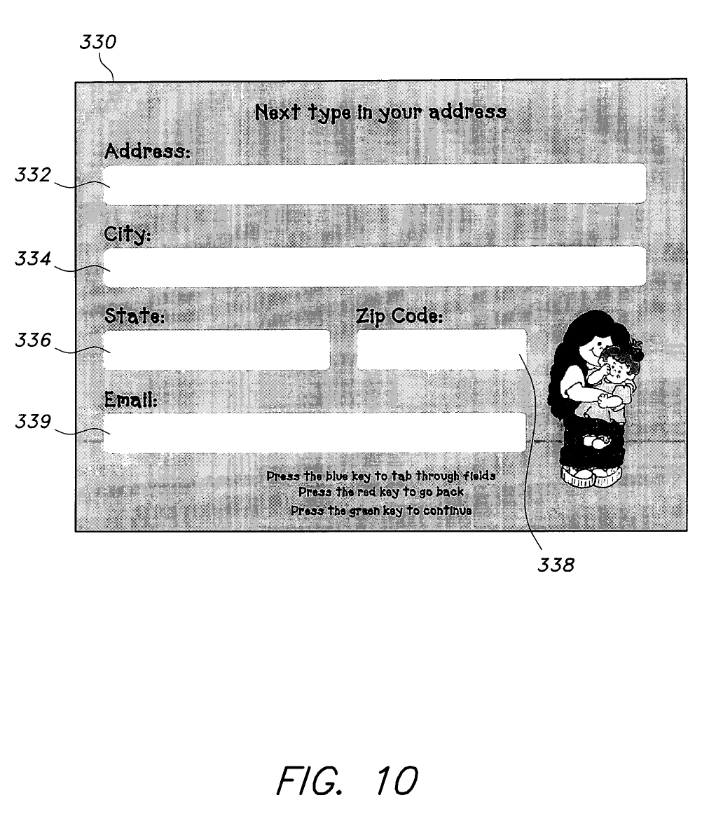

Computer program code at step 308 causes a second customer information page 330, shown in FIG. 10, to be displayed on the workstation display 1116. The second customer information page 330 includes text boxes 332, 334, 336, 338, and 339, for entry of the customer's address, including the customer street address, city, state, zip code, and email address. Computer program code at step 310 accepts keystrokes entered by the user. The keystrokes may be alphanumeric characters, which are entered into the textboxes 332, 334, 336, 338, or 339, or a continue key. If the continue key is pressed, computer program code at step 312 updates the database 1308 with the customer's address. A “go back” key may be entered to revert to the previous page.

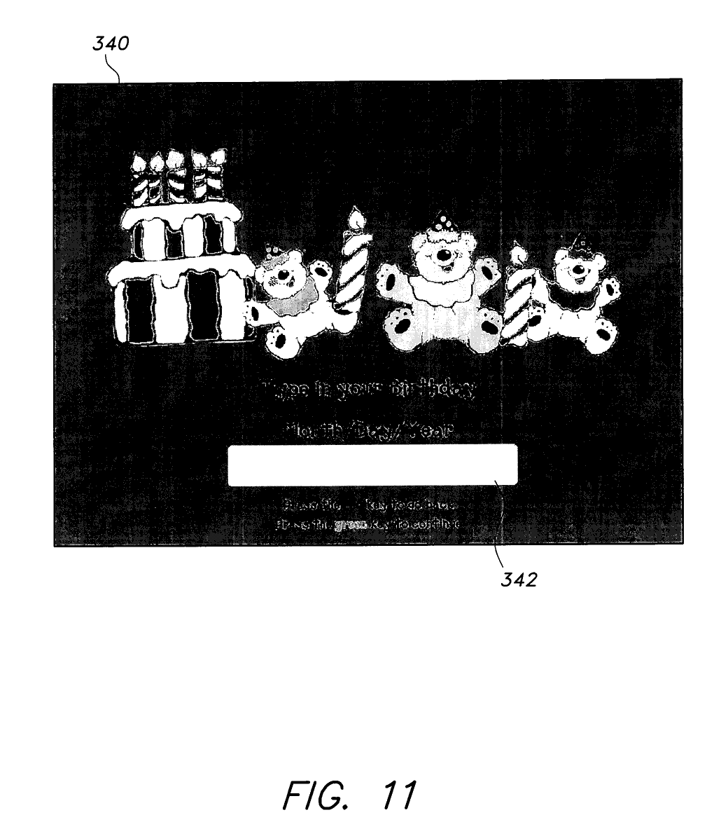

Computer program code at step 314 causes a third customer information page 340, shown in FIG. 11, to be displayed on the workstation display 1116. The third customer information page 340 includes a text box 342 for entry of the customer's birthday. Computer program code at step 316 accepts keystrokes entered by the user. The keystrokes may be alphanumeric characters, which are entered into the textbox 342, or a continue key. If the continue key is pressed, computer program code at step 318 updates the database 1308 with the customer's birthday. The customer information activity 300 is completed and the computer program code moves to the next activity. A “go back” key may be entered to revert to the previous page.

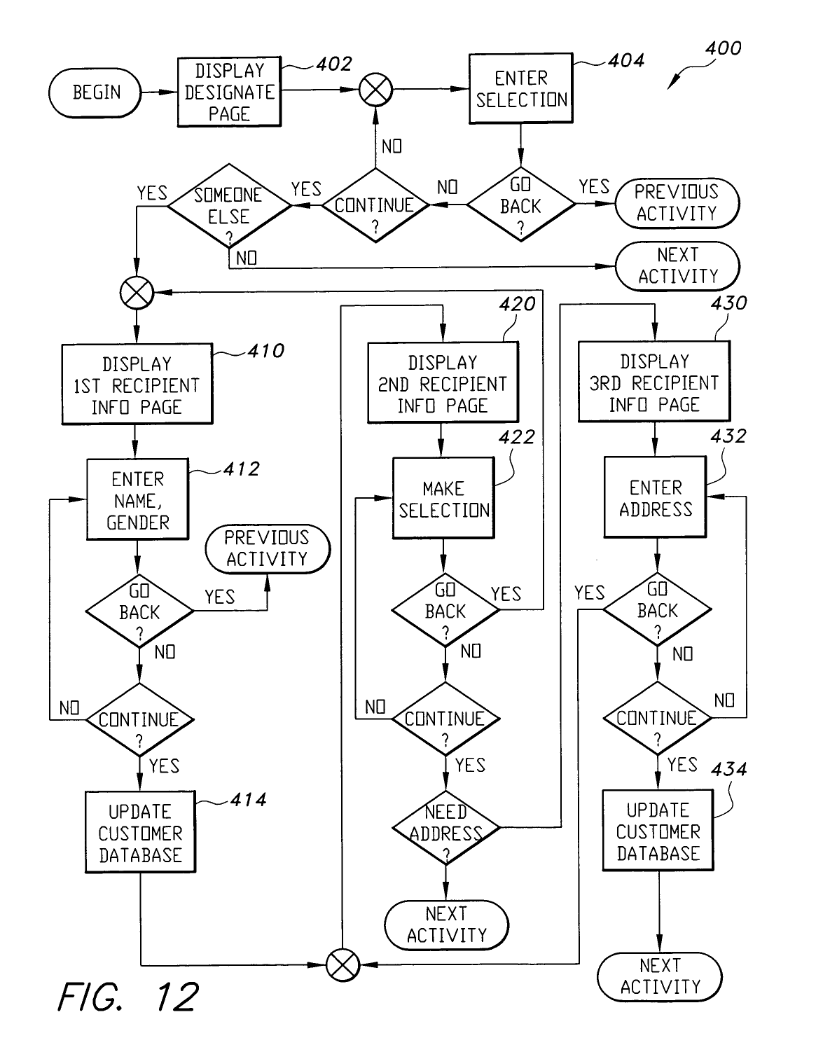

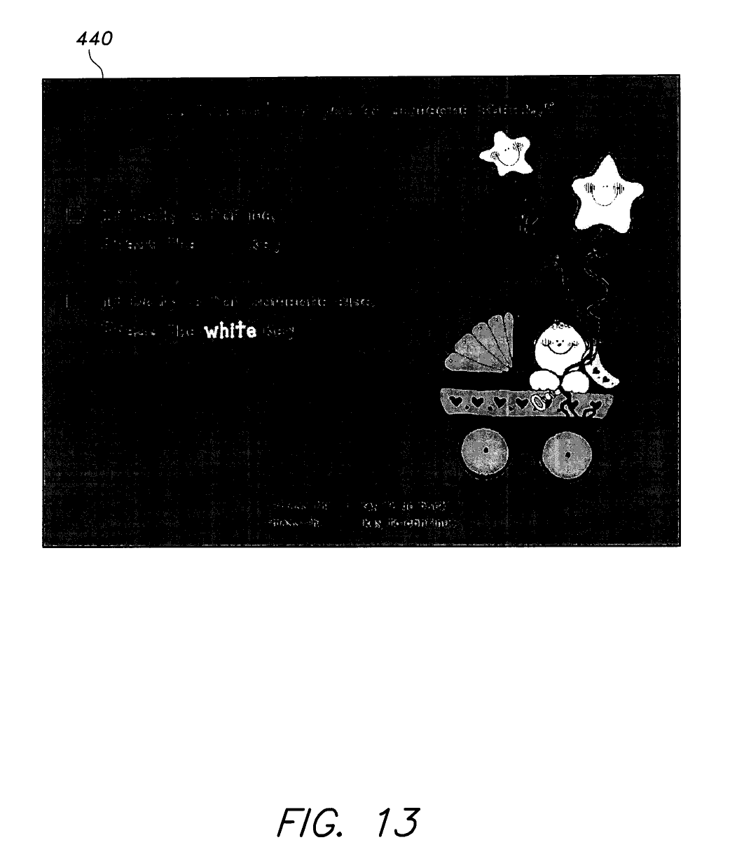

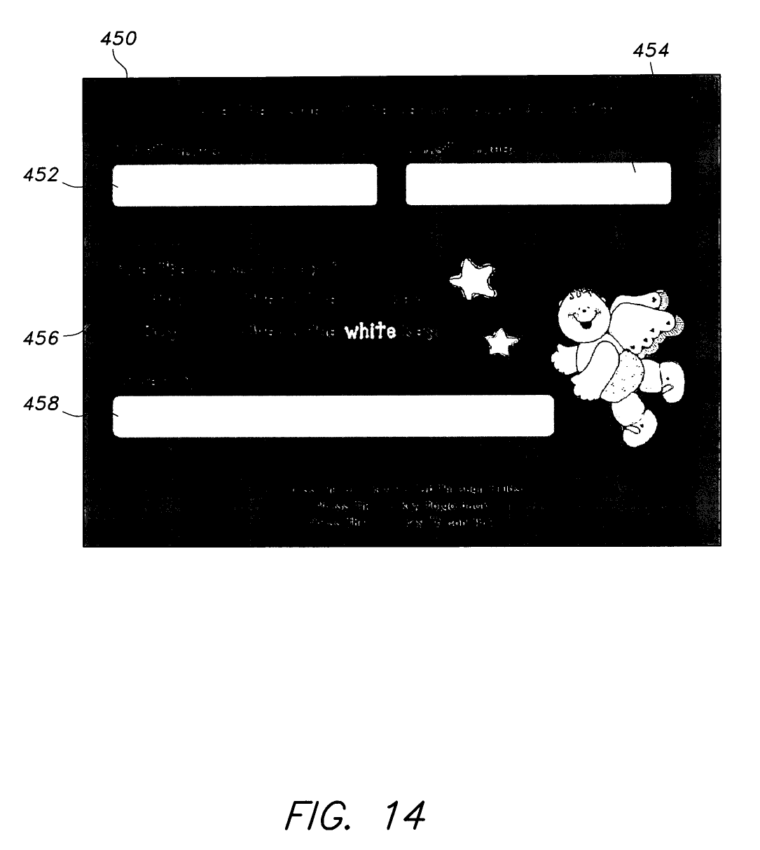

Turning now to FIGS. 12-16, the designate recipient activity 400 is detailed. Computer program code at step 402 causes a recipient designation page 440, shown in FIG. 13, to be displayed on the workstation display 1116. A recipient may be designated, for example, when the doll is to be given as a gift to another person. The recipient designation page 440 displays a prompt for the customer to indicate whether the doll is for the customer or to be given to someone else. Computer program code at step 404 accepts keystrokes entered by the user. The keystrokes may be color-coded keys indicating the selection, a continue key, or a “go back” key. If the continue key is pressed, and the doll is for someone else, computer program code at step 410 causes a first recipient information page 450, shown in FIG. 14, to be displayed on the workstation display 1116. If the continue key is pressed, and the doll is for the customer, the designate recipient activity 400 is completed and the computer program code moves to the next activity. A “go back” key may be entered to revert to the previous page.

The first recipient information page 450 includes text boxes 452, 454, for entry of the recipient's first and last names, a selection list 456 allowing selection of the recipient's gender, and a text box 458 for entry of the name of the person giving the gift. Computer program code at step.412 accepts keystrokes entered by the user. The keystrokes may be alphanumeric characters, which are entered into the textboxes 452, 454, and 458, color-coded keys corresponding to the selections in the selection list 456, or a continue key. If one of the color-coded keys corresponding to the selections in the selection list 456 is pressed, the recipient's gender is set. If the continue key is pressed, computer program code at step 414 updates the database 1308 with the recipient information. A “go back” key may be entered to revert to a previous activity.

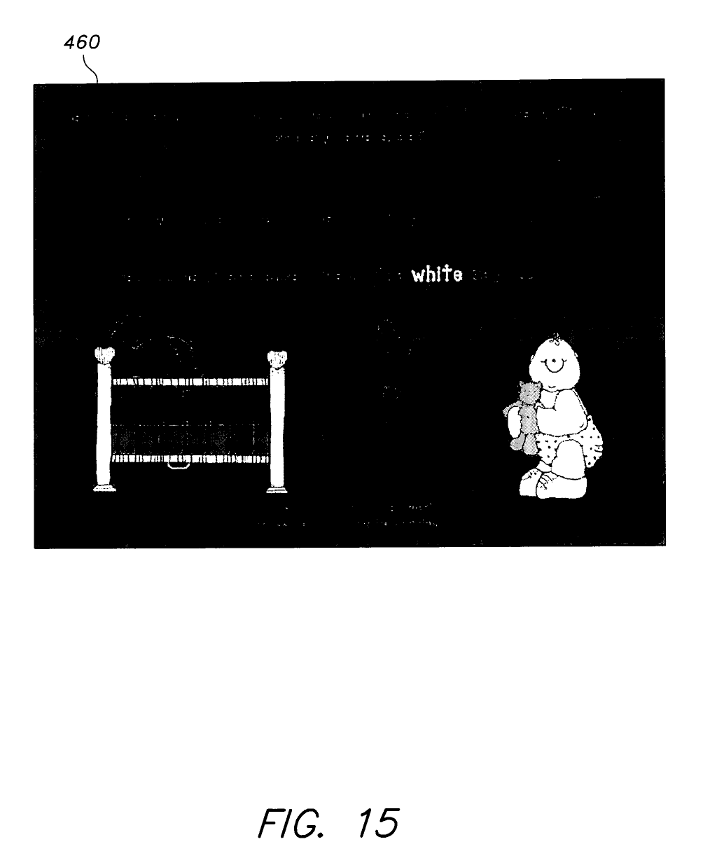

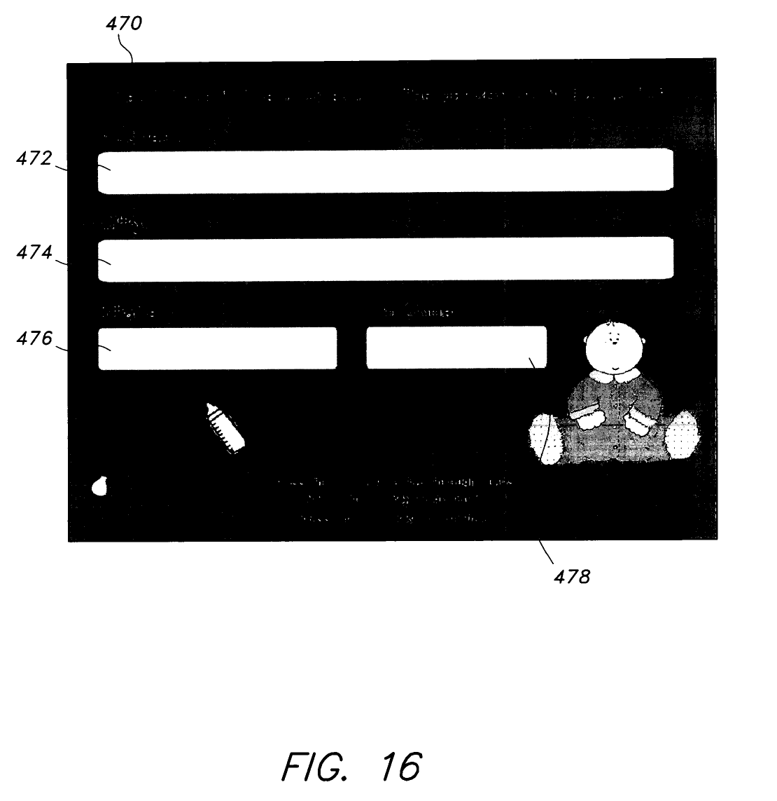

Computer program code at step 420 displays a second recipient information screen 460, seen in FIG. 15. The second recipient information page 460 displays a prompt for the customer to indicate whether the recipient lives with the customer or at another address. Computer program code at step 422 accepts keystrokes entered by the user. The keystrokes may be color-coded keys indicating a selection, a continue key or a “go back” key. If the continue key is pressed, and the recipient has a different address from the customer, computer program code at step 430 causes a third recipient information page 470, shown in FIG. 16, to be displayed on the workstation display 470. If the continue key is pressed, and the recipient's address is the same as the customers, the designate recipient activity 400 is completed and the computer program code moves to the next activity. A “go back” key may be entered to revert to the previous page.

The third recipient information page 470 includes text boxes 472, 474, 476, and 478 for entry of the recipient's address, including the recipient street address, city, state, and zip code. Computer program code at step 432 accepts keystrokes entered by the user. The keystrokes may be alphanumeric characters, which are entered into the textboxes 472, 474, 476, or 478, or a continue key. If the continue key is pressed, computer program code at step 434 updates the database 1308 with the recipient address, and the designate recipient activity 400 is completed and the computer program code moves to the next activity. A “go back” key may be entered to revert to the previous page.

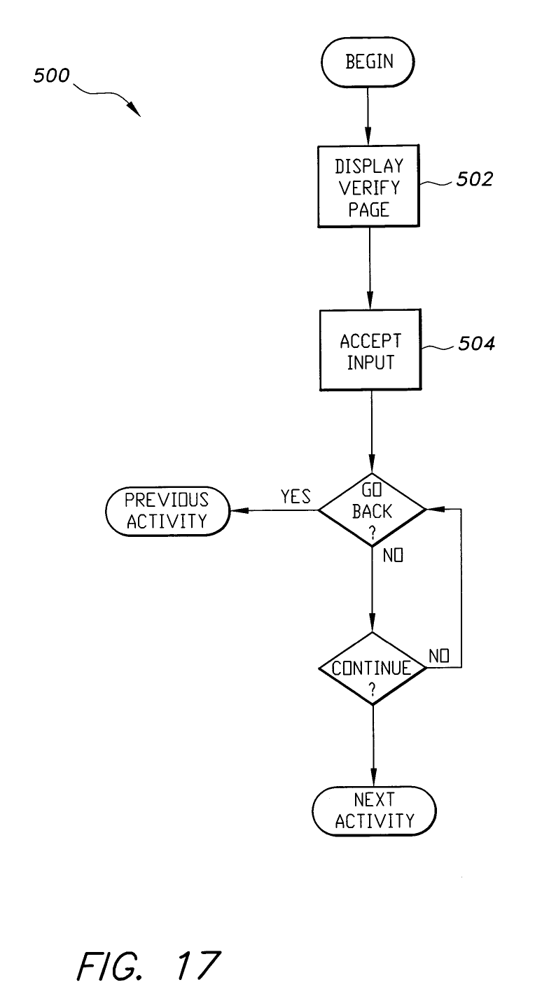

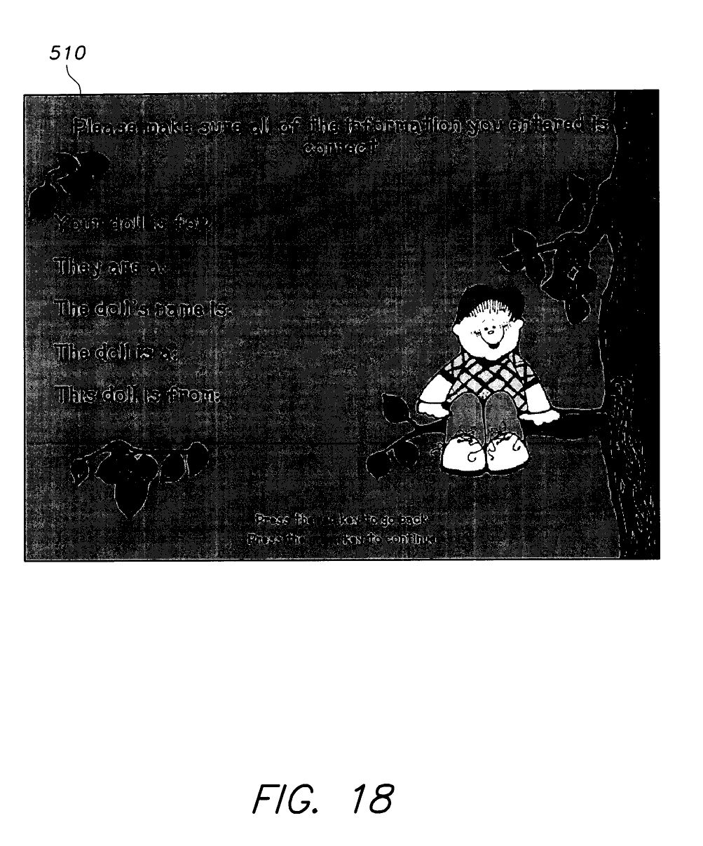

Turning now to FIGS. 17-18, the verification activity 500 is detailed. Computer program code at step 502 the causes a verify page 510, shown in FIG. 18, to be displayed on the workstation display 1116. The verify page 510 shows all of the information that has been entered by the customer for verification. Computer program code at step 504 accepts keystrokes entered by the user. If the continue key is pressed, the verification of information activity 500 is completed and the computer program code moves to the next activity. A “go back” key may be entered to revert to a previous page.

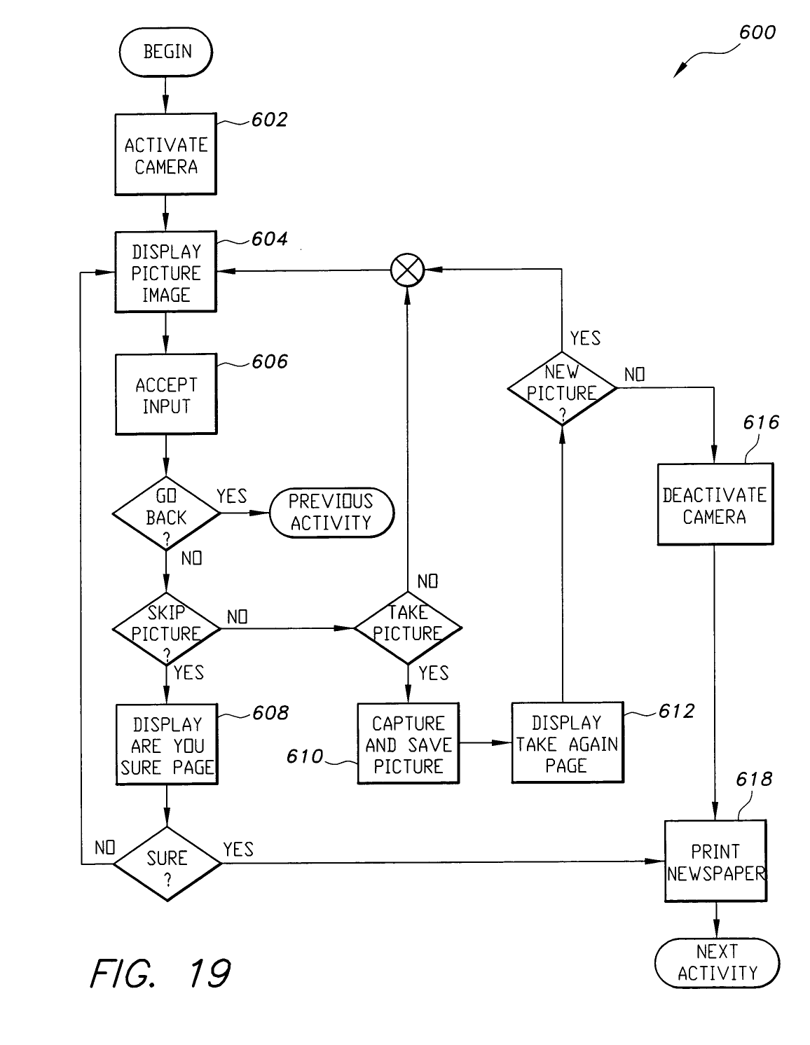

Turning now to FIGS. 19-22, the print newspaper activity 600 is detailed. During the print newspaper activity 600, the customer 10 may have her picture taken and printed out, along with information about the customer, or the recipient, and the new doll, on a personalized memento that is formatted to have the appearance of a newspaper or newsletter's front page and printed by printer 1200. Pre-printed paper having the appearance of a newspaper or newsletter's front page may be used in the printer 1200, with only the customer unique information and picture being printed. Alternatively, predefined graphic and textual data defining the appearance of a newspaper or newsletter's front page may be contained within the program code or data and printed on a blank paper along with the customer unique information.

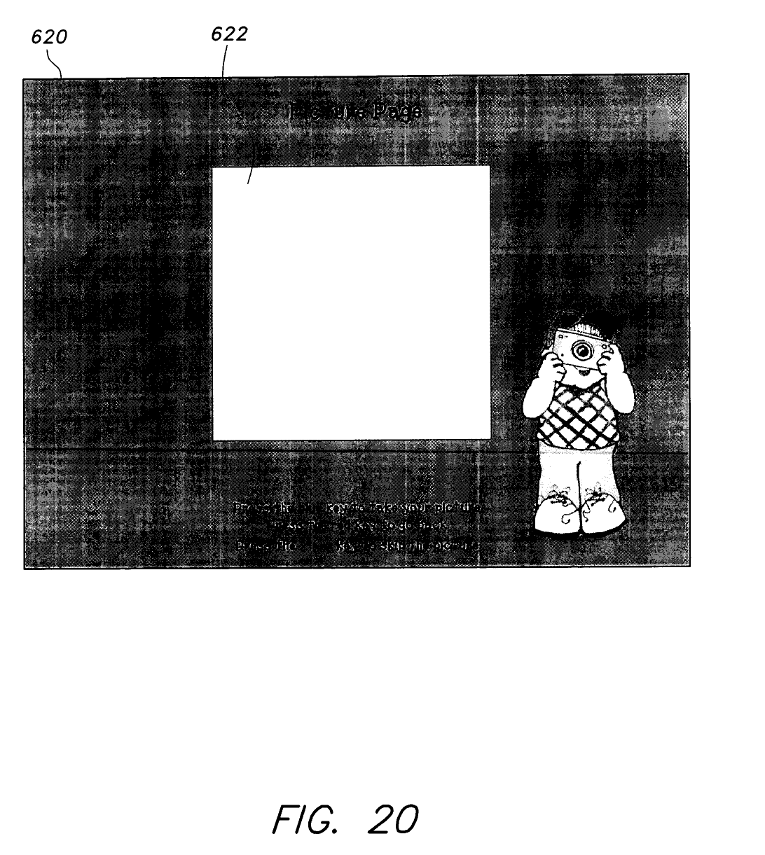

Computer program code at step 602 activates the digital camera 1118, and computer program code at step 604 the causes a display picture page 620, shown in FIG. 20, to be displayed on the workstation display 1116. The display picture page 620 has a picture box 622, where the image from the digital camera 1118 is shown. The digital camera 1118 preferably provides a live image that is continuously updated in the picture box 622. Alternatively, of course, a “single shot” digital camera could be used and a static image displayed.

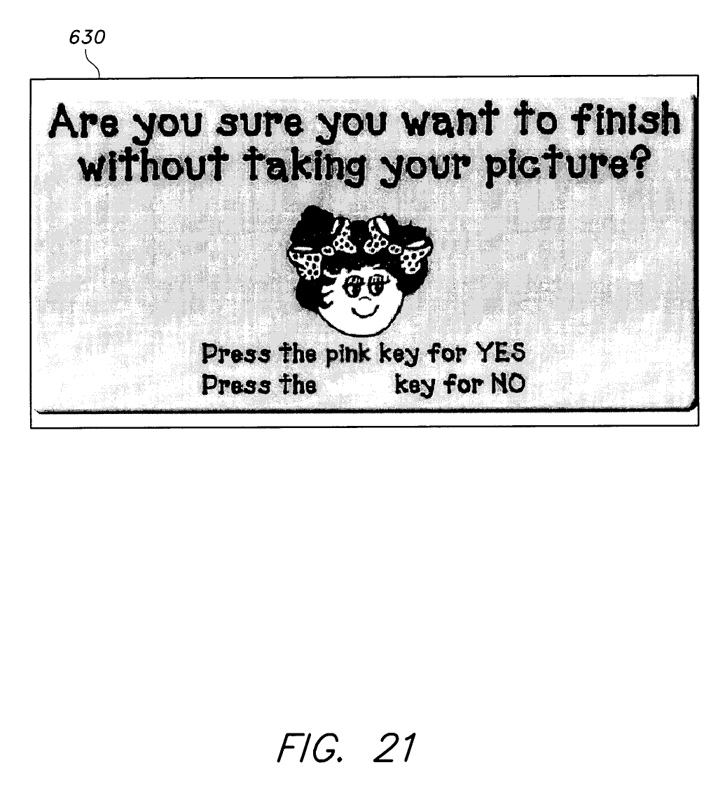

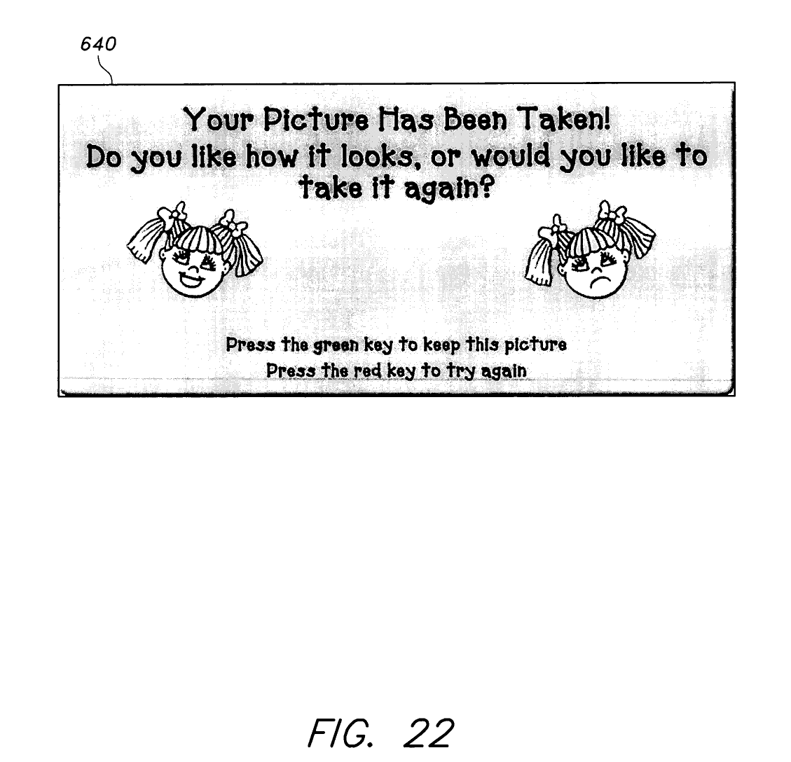

Computer program code at step 606 accepts commands entered by the user. The command may be to take the picture, to skip the picture, or to “go back”. If the command is to skip the picture, computer code at step 608 displays an “are you sure” page 630, seen in FIG. 21, and accepts keystrokes for “yes” and “no” answers. If the answer is “yes” computer program code at step 618 will proceed to print the newspaper without a photo. A “no” answer returns to the display picture page 620 at step 604. If the command is to take the picture, computer program code at step 610 stores the presently displayed digital image. Computer program code at step 612 displays a page 640 with the option to re-take the picture, seen in FIG. 22, and accepts a “yes” or “no” answer. A “yes” answer returns to the display picture page 620 at step 604, to re-take the picture. If the answer is “no”, computer program code at step 616 deactivates the digital camera 1118. Computer program code at step 618 extracts personalizing information from the database 1308, including doll and customer information, formats the personalizing information along with the picture, and prints the newspaper.

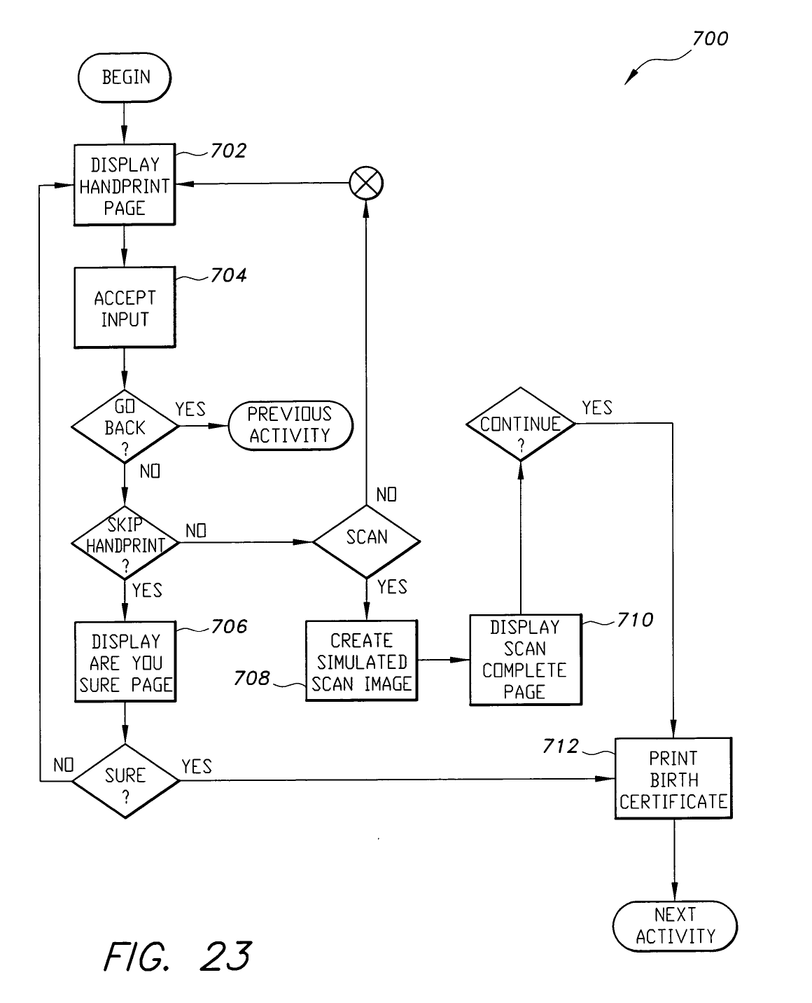

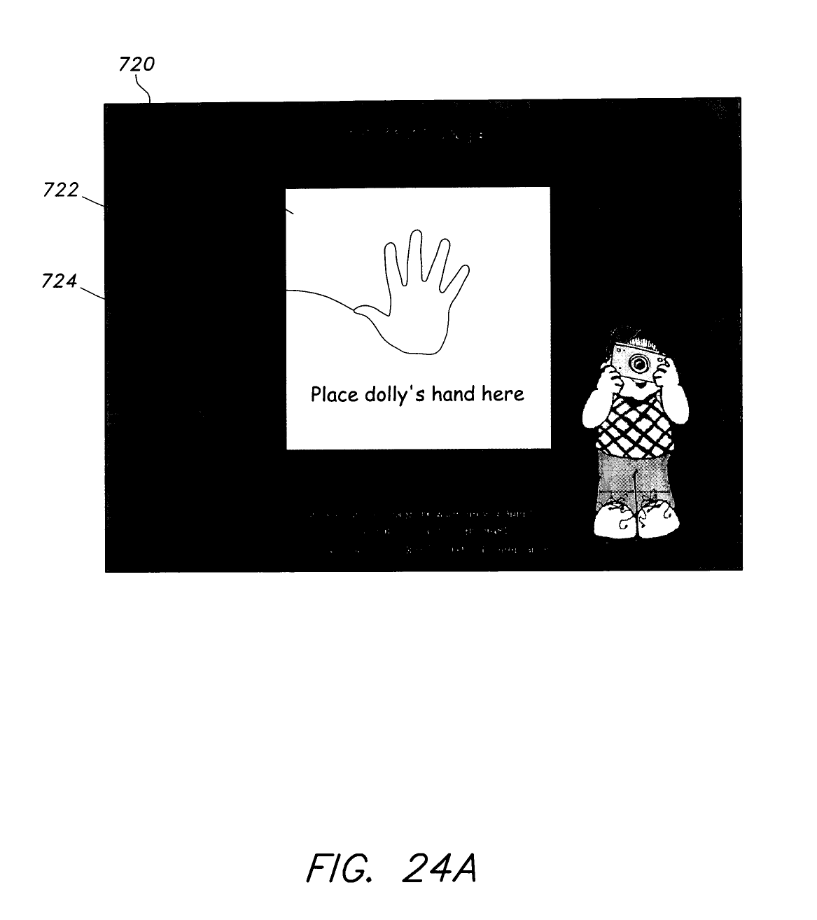

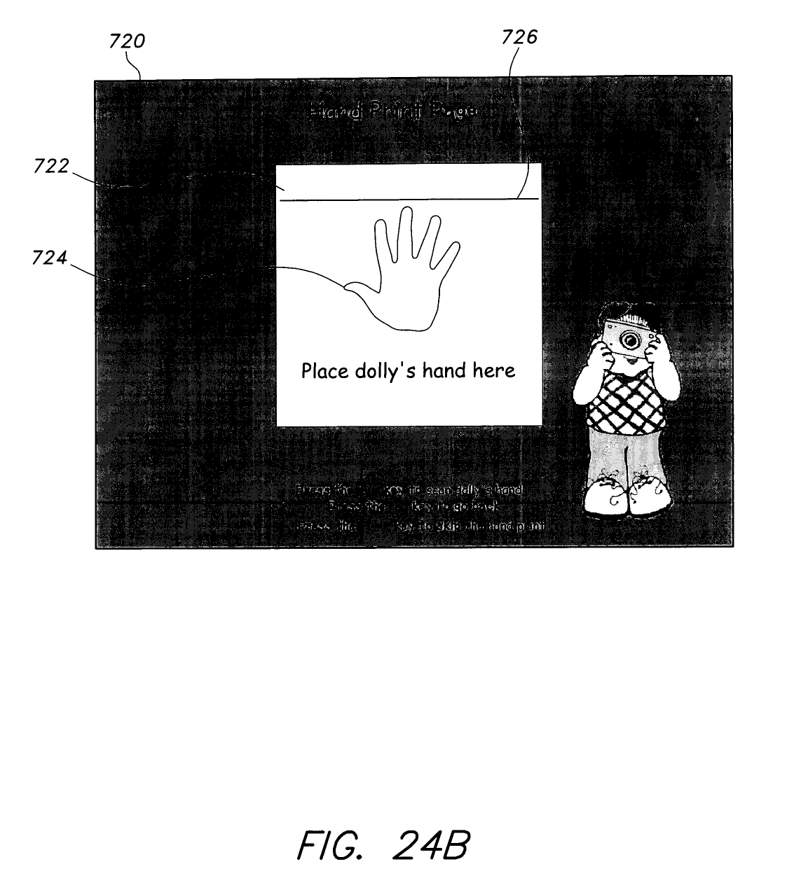

Turning now to FIGS. 23-24B, the print birth certificate activity 700 is detailed. During the print birth certificate activity 700, the customer 10 may have her doll's hands and feet scanned, and a personalized memento printed, by printer 1200, that is formatted to have the appearance of a birth certificate bearing the doll's handprints and footprints. The actual scanning of the doll's hands and feet is simulated, and the handprint and footprint images printed on the birth certificate are pre-defined and contained within the program code or data.

Computer program code at step 702 causes a handprint page 720, shown in FIG. 24A, to be displayed on the workstation display 1116. The handprint page 720 displays a hand-scanning region 722 with a handprint outline 724, having the general appearance of a hand-scanning device, and instructions to place the doll's hand against the screen. Computer program code at step 704 accepts commands entered by the user. The command may be to perform a scan, to skip the scan, or to “go back”. If the command is to skip the scan, computer code at step 706 displays an “are you sure” page and accepts keystrokes for “yes” and “no” answers. If the answer is “yes” computer program code at step 712 will proceed to print the birth certificate without handprints or footprints. A “no” answer returns to the handprint page 720 at step 702. If the command is to perform the scan, computer program code at step 708 generates a display image to simulate a hand-scanning device in action. One example of a display image that simulates a hand-scanning device in action is the display of a scan-line 726 that sweeps across the hand-scanning region 722. Alternatively, the hand-scanning region 722 could be caused to flash or change color. Additionally, the computer program code generates an audio sound to add authenticity to the simulation, the sound being played over the at least one audio speaker 1120. Computer program code at step 710 displays a scan completed page with a prompt to continue to print the birth certificate. In an alternative embodiment of the handprint activity, the computer program code steps repeat to sequentially scan both of the doll's hands and both feet. In another alternative, the display pages are formatted to scan both hands and both feet in one scan simulation. Computer program code at step 712 formats customer data and prints, by printer 1200, customer data along with the pre-defined hand and foot print images on the birth certificate. Computer program code at step 712 extracts personalizing information from the database 1308, including doll and customer information, formats the personalizing information, and prints the birth certificate. A similar process is used for scanning the footprint, the screenshots being similar to those for the handprints shown in FIGS. 24A and 24B.

Pre-printed paper having the appearance of a birth certificate including hand and foot prints may be used in the printer 1200, with only the personalizing information being printed. Alternatively, predefined graphic and textual data defining the appearance of a birth certificate may be contained within the program code or data and printed on a blank paper along with the customer unique information. In another alternative approach, pre-printed paper having the appearance of a birth certificate but without the hand and foot prints is used, with hand and foot prints generated from predefined graphic and textual data defining the appearance of the foot prints contained within the program code or data and formatted along with the personalizing information.

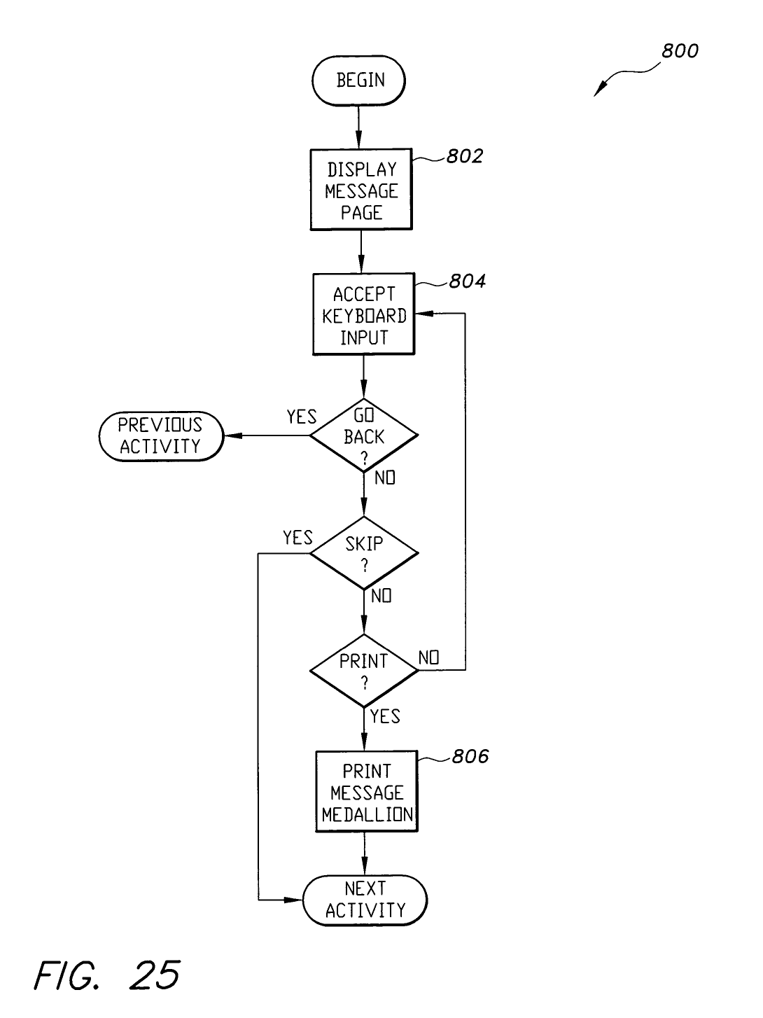

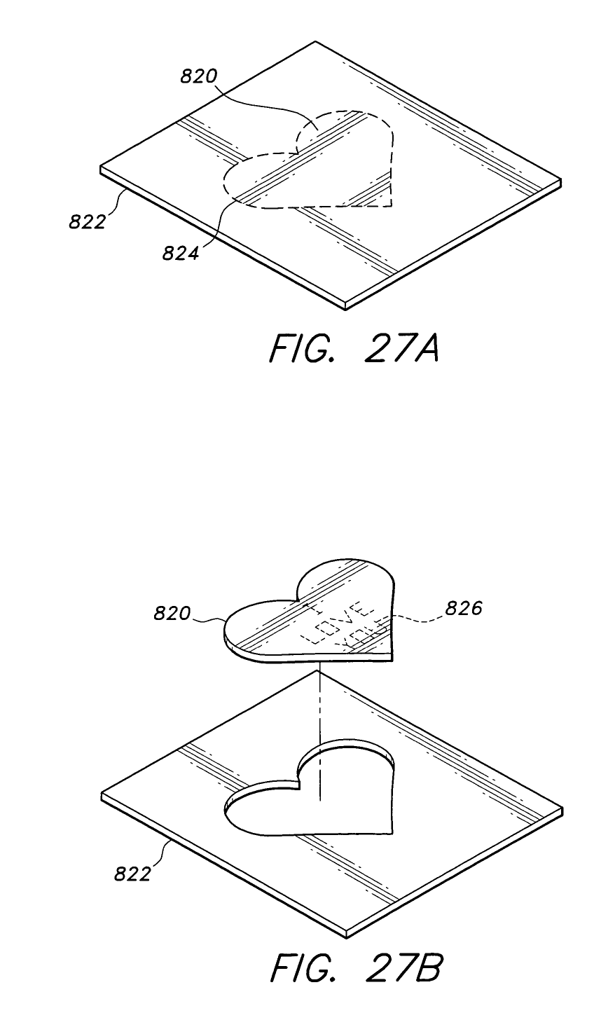

Turning now to FIGS. 25-28, the create message medallion activity 800 is detailed. During the create message medallion activity 800, the customer 10 may enter a personalized message, or select a message from a list of predefined messages, to be printed by printer 1200 onto a message medallion 820, shown in FIGS. 27A and 27B.

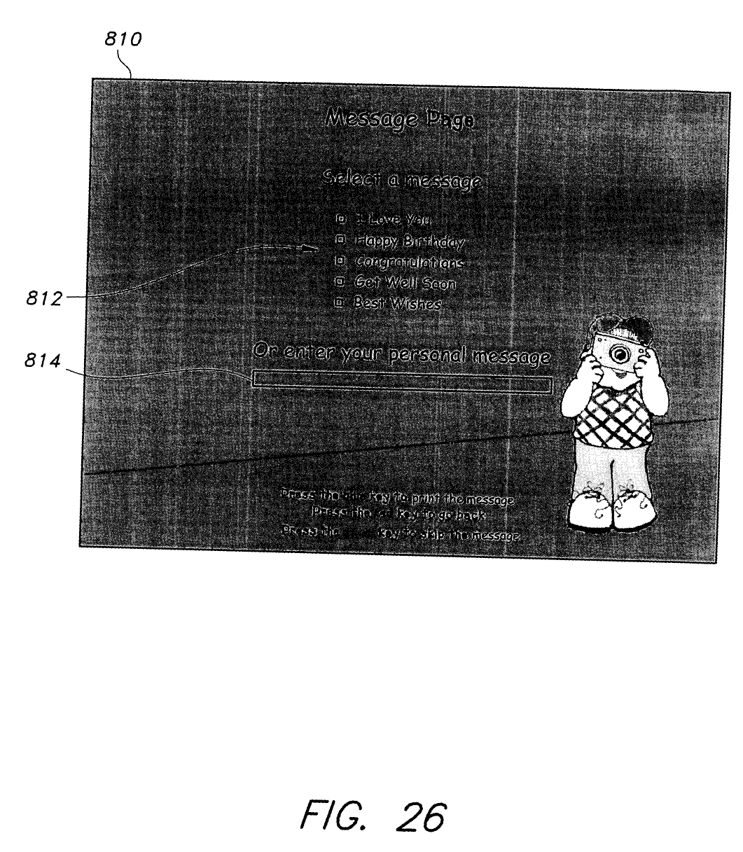

Computer program code at step 802 causes a message page 810, shown in FIG. 26, to be displayed on the workstation display 1116. The message page 810 includes a message selection list 812 and a message text box 814 for entry of a personalized message. The message selection list 812 includes a plurality of predefined messages.

Computer program code at step 804 accepts keystrokes entered by the user for either entry of a personalized message in the message text box 814 or selection of a predefined message from the message selection list 812. Additionally, commands are accepted to go back to a previous activity, to skip the message medallion activity, or to print the message medallion. If the customer enters the command to print the message medallion, computer program code at step 806 prints the customer's message onto a message medallion 820.

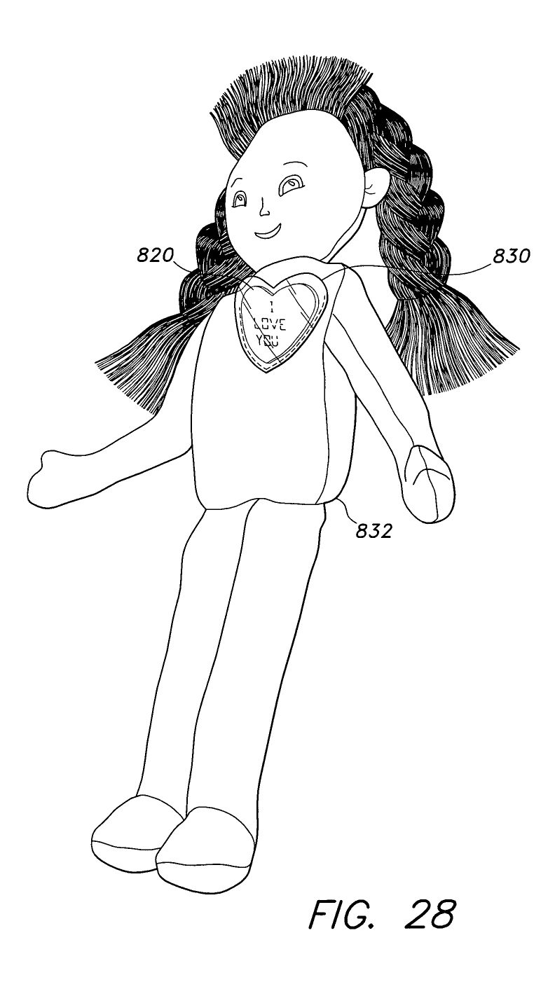

In a preferred embodiment, the message medallion 820, shown in FIGS. 27A and 27B, is part of a standard sized sheet of heavy paper or card stock 822. Perforations 824 are formed in the heavy paper or card stock 822, defining the perimeter of the message medallion 820, whereby the message medallion 820 can be separated from the heavy paper or card stock 822. This allows the personalized message 826 to be printed onto the message medallion 820 by a conventional laser printer or a similar printing device. As seen in FIG. 28, the message medallion 820 may fit into a message pocket 830 on the front of a doll 832.

It is to be understood that the present invention is not limited to the embodiments described above, but encompasses any and all embodiments within the scope of the following claims.

1. A computerized method for interactive retail sale of a stuffed toy to a customer, comprising the steps of:
inputting information relating to the stuffed toy and entering the information relating to the stuffed toy into a database;
inputting the customer's personal identifying information and entering the customer's personal identifying information into the database;
inputting information relating to a designated recipient for the stuffed toy and entering the information relating to a designated recipient for the stuffed toy into the database; and
printing a personalized memento.

2. The computerized method for interactive retail sale of a stuffed toy to a customer according to claim 1, wherein the step of printing a personalized memento further comprises the steps of:
taking a digital photo of the customer;
extracting memento personalizing information from the database;
formatting the memento personalizing information along with the digital photo of the customer for printing; and
printing a personalized memento that includes the memento personalizing information and the digital photo of the customer.

3. The computerized method for interactive retail sale of a stuffed toy to a customer according to claim 1, wherein the step of printing a personalized memento further comprises the steps of:
performing a simulated handprint and footprint scanning operation;
extracting memento personalizing information from the database;
formatting the memento personalizing information for printing; and
printing a personalized memento that includes the memento personalizing information.

4. The computerized method for interactive retail sale of a stuffed toy to a customer according to claim 3, wherein the step of performing a simulated handprint and footprint scanning operation further comprises the steps of:
displaying on a computer display a graphic image depicting a hand and foot scanning area;
instructing the customer to press a hand or foot of the stuffed toy against the computer display in the hand and foot scanning area; and
displaying on the computer display a graphic image that is suggestive of a hand and foot print scanning operation.

5. The computerized method for interactive retail sale of a stuffed toy to a customer according to claim 1, wherein the step of printing a personalized memento further comprises the steps of:
inputting a personalized message from the customer;
formatting the personalized message for printing on a message medallion; and
printing a the personalized message on a message medallion.

6. The computer program product that includes a medium readable by a processor, the medium having stored thereon a set of instructions comprising:
a first sequence of instructions which, when executed by the processor, causes the processor to input information relating to a customer's purchase and enter the customer's purchase information into a database;
a second sequence of instructions which, when executed by the processor, causes the processor to input said customer's personal identifying information and enter the personal identifying information into a database;
a third sequence of instructions which, when executed by the processor, causes the processor to input information relating to a designated recipient for said customer's purchase and enter the information relating to a designated recipient into a database; and
a fourth sequence of instructions which, when executed by the processor, causes the processor to obtain memento personalizing information, format the memento personalizing information for printing on a memento, and print the memento personalizing information on a personalized memento.

7. The computer program product according to claim 6, wherein said fourth sequence of instructions further comprises:
a sequence of instructions which cause the processor to take a digital photo of the customer;
a sequence of instructions which cause the processor to extract memento personalizing information from the database;
a sequence of instructions which cause the processor to format the memento personalizing information along with the digital photo of the customer for printing; and
a sequence of instructions which cause the processor to print a personalized memento that includes the memento personalizing information and the digital photo of the customer.

8. The computer program product according to claim 6, wherein said fourth sequence of instructions further comprises:
a sequence of instructions which cause the processor to perform a simulated handprint and footprint scanning operation;
a sequence of instructions which cause the processor to extract memento personalizing information from the database;
a sequence of instructions which cause the processor to format the memento personalizing information for printing; and
a sequence of instructions which cause the processor to printing a personalized memento that includes the memento personalizing information.

9. The computer program product according to claim 8, wherein said sequence of instructions which cause the processor to perform a simulated hand and foot print scanning operation further comprises:
a sequence of instructions which cause the processor to display on a computer display a graphic image depicting a hand and foot scanning area;
a sequence of instructions which cause the processor to instruct the customer to press a hand or foot of the stuffed toy against the computer display in the hand and foot scanning area; and
a sequence of instructions which cause the processor to display on the computer display a graphic image that is suggestive of a hand and foot print scanning operation.

10. The computer program product according to claim 6, wherein said fourth sequence of instructions further comprises:
a sequence of instructions which cause the processor to input a personalized message from the customer;
a sequence of instructions which cause the processor to format the personalized message for printing on a message medallion; and
a sequence of instructions which cause the processor to print a the personalized message on a message medallion.

11. A computerized system for interactive retail sale of a stuffed toy, comprising:
at least one workstation computer, each workstation computer having a processor, an area of main memory for executing program code under the direction of the processor, a storage device for storing program code and data, a workstation bus connecting the processor, the main memory, and the storage device, a digital camera in communication with the workstation computer and at least one audio speaker in communication with the workstation computer;
at least one database in communication with said at least one workstation computer;
at least one printer in communication with said at least one workstation computer;
a computer program stored in said storage device and executing in said main memory under the direction of said processor, the computer program including:
means for inputting information relating to the stuffed toy and entering the information relating to the stuffed toy into a database;
means for inputting a customer's personal identifying information and entering the customer's personal identifying information into a database;
means for inputting information relating to a designated recipient for the stuffed toy and entering the information relating to a designated recipient for the stuffed toy into a database; and
means for obtaining memento personalizing information, formatting the memento personalizing information for printing on a memento, and printing the memento personalizing information on a personalized memento.

12. The computerized system for interactive retail sale of a stuffed toy according to claim 11, further comprising:
a data communication network;
at least one server computer having a processor, an area of main memory for executing program code under the direction of the processor, a storage device for storing program code and data, a data communication device in communication with said data communication network, and a server bus connecting the processor, the storage device, and the data communication device;
wherein each of said at least one workstation computers further comprises a data communication device connected to said workstation bus and in communication with said data communication network;
wherein said at least one database is maintained on the server computer; and
wherein each of said at least one printer is connected to said network and is in communication with said at least one workstation computer over said network.
